(19) United States
(12) Patent Application Publication
(10) Pub. No.: US 2024/0428364 A1
(43) Pub. Date: Dec. 26, 2024

(54) SELECTIVE PREFETCH ENGINE FOR RESOURCE EFFICIENT IMAGE RENDERING

(71) Applicant: QUALCOMM Incorporated, San Diego, CA (US)

(72) Inventors: Nigel Poole, West Newton, MA (US); Edwin Jose Africano, Marlborough, MA (US)

(21) Appl. No.: 18/341,233

(22) Filed: Jun. 26, 2023

(51) Int. Cl. G06T 1/20; G06F 12/02; G06T 1/60

(52) U.S. Cl. CPC G06T 1/20; G06F 12/0215; G06T 1/60; G06F 2212/1024

(57) ABSTRACT

Disclosed is a method for rendering a frame. The method is executed by a graphics processor and comprises dividing the frame into a plurality of bins. For each bin of the plurality of bins, the method comprises fetching a subset of entries corresponding to visible draw calls of a fixed stride draw table (FSDT). The FSDT comprises a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin. The disclosed method further comprises executing the fetched subset of entries corresponding to visible draw calls.

### INTRODUCTION

Aspects of the present disclosure generally relate to rendering of frames, and more specifically to tiled rendering by using fixed-stride draw tables.

### BACKGROUND

A device that provides content for visual presentation on an electronic display generally includes a graphics processing unit (GPU). The GPU (in conjunction with other components) renders pixels that are representative of the content on the display. That is, the GPU generates values for each pixel on the display and performs graphics processing on the pixel values to render each pixel for presentation. For example, the GPU may convert two-dimensional or three-dimensional virtual objects (sometimes denoted as “draws” or “primitives”) into a two-dimensional pixel representation that may be displayed. Converting information about three-dimensional objects into a bitmap that can be displayed in two dimensions is known as pixel rendering and requires considerable memory and processing power.

Three-dimensional graphics accelerators that support pixel rendering operations are becoming increasingly available in devices such as personal computers, smartphones, tablet computers, gaming devices, etc. Such devices may in some cases have constraints on computational power, memory capacity, and/or other processing parameters. Accordingly, three-dimensional graphics rendering may present difficulties when being implemented on these devices.

In a binned rendering GPU, many of the draws may be invisible if their final pixels are not in a bin which is currently of interest. Such invisible draws may not need to be processed, and their associated state of the fixed-stride draw table (FSDT) may be ignored.

However, these table entries are generally fetched on an as-needed basis, depending on the visibility state of the respective draws. This causes latency in the command processor (CP).

To avoid this, table entries may be pre-fetched. This pre-fetching can result in over-fetch, as some unnecessary draws may be fetched, which wastes time, power and computational resources for the fetching of unnecessary draws.

Thus, it is an object of the present disclosure to provide an improved fetching method which allows for a more efficient use of power, time and computational resources.

### SUMMARY

The following presents a simplified summary relating to one or more aspects disclosed herein. A more detailed disclosure follows in the next section with reference to the appended drawings.

In some aspects of the present disclosure, a method for rendering a frame is provided. The method may be executed by a graphics processor. The method may comprise dividing the frame into a plurality of bins. The method may further comprise, for each bin of the plurality of bins, fetching a subset of entries corresponding to visible draw calls of a fixed stride draw table (FSDT) the FSDT comprising a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin. The method may further comprise executing the fetched subset entries corresponding to of visible draw calls.

In some aspects of the present disclosure, an apparatus is provided. The apparatus may comprise one or more processors, a memory in communication with the one or more processors. The apparatus may be configured to render a frame by: dividing the frame to be rendered into a plurality of bins; and for each bin of the plurality of bins: fetching a subset of entries corresponding to visible draw calls of an FSDT that comprises a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin; and executing the fetched subset of entries corresponding to visible draw calls, causing the one or more processors to render the frame.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, follows by reference to aspects, some of which are illustrated in the appended drawings. It is to be noted, however, that the appended drawings illustrate only some typical aspects of this disclosure and are therefore not to be considered limiting of its scope. The same reference numbers in different drawings may identify the same or similar elements.

FIG. 1 illustrates an example of a binning layout that supports fixed-stride draw tables for tiled rendering in accordance with aspects of the present disclosure.

FIG. 2 illustrates an example of a command stream that supports fixed-stride draw tables for tiled rendering in accordance with aspects of the present disclosure.

FIG. 3 is a flow diagram illustrating a fetching process of an FSDT Fetch engine (FFE) in accordance with aspects of the present disclosure.

FIG. 4 illustrates a structure of an FFE in accordance with aspects of the present disclosure.

FIG. 5 shows a block diagram of a device comprising a GPU that supports FSDTs for rendering in accordance with aspects of the present disclosure.

FIG. 6 shows a flowchart illustrating a method for rendering a frame in accordance with aspects of the present disclosure.

### DETAILED DESCRIPTION

Various aspects of the present disclosure are described in more detail hereinafter with reference to the accompanying drawings.

In tiled rendering (sometimes also denoted as binned rendering), some draws of a fixed-stride draw table (FSDT) may be invisible for a current bin of interest.

A FSDT may be a data structure or table that stores rendering-related information, such as vertex data, texture coordinates, or other attributes, using a predetermined step size or spacing (sometimes denoted as “stride”) for efficient data access and processing.

That is, when rendering a bin, some draws of the FSDT may not be located in the bin currently rendered. Additionally, some draws of the FSDT may be located in the bin currently rendered, but may be located behind another object, such that the draw is invisible although it is located within the bin currently rendered. Such draws located behind another object may sometimes be denoted as “occluded draws”. Pixels drawn by such draws may be denoted as “occluded pixels”. Therefore, the respective entries in the FSDT would not need to be processed when rendering the current bin of interest.

Further exemplary reasons for the invisibility of draws, such as predication or similar, will be readily understandable for the skilled person, although not discussed in detail herein.

However, fetching the table-entries as needed, i.e., only fetching the entries of the FSDT which are required at the time, may lead to latency in the command processor (CP), as the CP would have to request processing of each entry of the FSDT separately, and then wait for the command stream to be completed after fetching the respective entry from the FSDT.

A CP, also known as a command interpreter, may be a software or hardware component that interprets and executes entered commands. The CP may typically read input, analyze it, and execute appropriate actions or commands based on provided instructions.

To avoid such latency, table entries of the FSDT can be pre-fetched, i.e., the respective command stream can be generated from the FSDT prior to the request of the CO, such that the CP can access the respective command stream directly and without latency. However, when pre-fetching the entries of the FSDT, some invisible draws of the FSDT may also be fetched, although they would not be required for rendering the current bin of interest. This may lead to a waste in time, power and computational resources, since the CP would still have to process the invisible draws within the command stream, and each entry (including the entries for invisible draws) would have to be fetched from the main memory.

Therefore, aspects of the present disclosure provide for a method for rendering a frame which includes selective pre-fetching. In some aspects of the present disclosure, the selective pre-fetching may be carried out by an FSDT Fetch Engine (FFE) which may be programmed by the CP. Such an FFE may utilize a list of visible draws as generated for example by a Visible Stream Decoder (VSD). The FFE may then send a fetch request to the main memory in order to pre-fetch those entries of the FSDT which correspond to visible draws in the current bin of interest. This allows for selectively pre-fetching only those entries of the FSDT which correspond to visible draws, i.e., draws which are visible within the current bin of interest.

Thus, time, power and computational resources can be saved since the CP only needs to process the draws which are visible in the current bin of interest, and only those draws need to be fetched form the main memory. Further, the fetched table entries can be concatenated in a single command stream, to avoid overhead and latencies, thus improving the overall rendering efficiency.

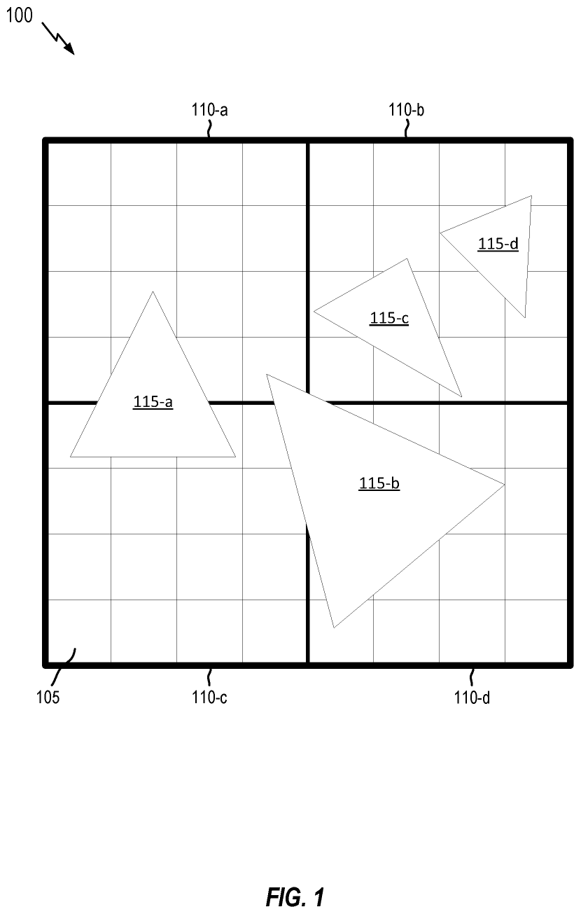

FIG. 1 illustrates an example of a binning layout 100 that supports fixed-stride draw tables for tiled rendering in accordance with aspects of the present disclosure. Binning layout 100 may illustrate a two-dimensional representation of a three-dimensional scene, where the two-dimensional representation may be displayed as a plurality of pixels 105. The two-dimensional representation may be generated based at least in part on primitives 115 (e.g., which are illustrated as triangles for the sake of explanation but may be other geometric shapes without deviating from the scope of the present disclosure). The plurality of pixels 105 comprising binning layout 100 may be divided into bins 110. Each bin 110 may have a same size and/or shape. Alternatively, the sizes and/or shapes of the bins 110 may vary.

Bin rendering may in some cases be described with respect to a number of processing passes. For example, when performing bin-based rendering, a central processing unit (CPU) or GPU may perform a visibility pass and one or more rendering passes. With respect to the visibility pass, the CPU (or GPU) may process an entire image and sort rasterized primitives 115 into bins 110. A visibility stream may be used to indicate the primitives 115 that are visible in the final image and the primitives 115 that are invisible in the final image. For example, a primitive 115 may be invisible if it is obscured by one or more other primitives 115 such that the primitive 115 cannot be seen in the final reconstructed image. A visibility stream may be generated for an entire image, or may be generated on a per-bin basis (e.g., one visibility stream for each bin 110). Generally, a visibility stream may include a series of bits, with each “1” or “0” being associated with a particular primitive 115. Each “1” may, for example, indicate that the primitive 115 is visible in the final image, while each “0” may indicate that the primitive 115 is invisible in the final image. In some cases, the visibility stream may control the rendering pass(es). For example, the visibility stream may be used to forego the rendering of invisible primitives 115. Accordingly, only the primitives that actually contribute to a bin 110 (e.g., that are visible in the final image) may be rendered and shaded, thereby reducing a number of rendering and shading operations performed by the GPU (e.g., resulting in power savings, improved throughput, or other such benefits).

In other examples, the CPU or GPU may use a different process (e.g., other than or in addition to the visibility streams described above) to classify primitives 115 as being located in (e.g., and visible in) a particular bin 110. For example, a GPU may output a separate list per bin 110 of “indices” that represent only the primitives 115 that are present in a given bin 110. For example, the GPU may initially include all the primitives 115 (e.g., vertices defining the primitives 115) in one data structure. The GPU may generate a set of pointers into the data structure for each bin 110 that only points to the primitives 115 that are visible in each bin 110. Such pointers may serve a similar purpose as the visibility streams described above, with the pointers indicating which primitives 115 are visible in a particular bin 110 (e.g., and which pixels 105 are associated with those primitives 115).

Each bin 110 may be rendered/rasterized (e.g., by a GPU) to contain multiple pixels 105, which pixels 105 may be shown via a display. One or more primitives 115 may be visible in each bin 110. For example, portions of primitive 115-a may be visible in both bin 110-a and bin 110-c. Portions of primitive 115-b may be visible in bin 110-a, bin 110-b, bin 110-c, and bin 110-d. Primitive 115-c and primitive 115-d are only visible in bin 110-b. Binning layout 100 may include other primitives 115, at least some of which may not be visible in the final rendering target. During a rendering pass for a given bin 110, all visible primitives 115 in that bin 110 may be rendered. For example, a visibility pass may be performed for each bin 110 (e.g., or for the frame as a whole during a visibility pass) to determine load estimation information and/or to determine which primitives 115 are visible in the final rendered scene. The visibility pass may be performed by a GPU or by specialized hardware (e.g., a hardware accelerator), which may be referred to as a visibility stream processor. For example, some primitives 115 may be behind one or more other primitives 115 (e.g., may be occluded), and such occluded primitives 115 may not need to be rendered for a given bin 110.

For a given rendering pass, the pixel data for the bin 110 associated with that particular rendering pass may be stored in a GPU memory. After performing the rendering pass, the GPU may transfer the contents of the GPU memory to a display buffer. In some cases, the GPU may overwrite a portion of the data in the display buffer with the rendered data stored in the GPU memory. After transferring the contents of GPU memory to the display buffer, the GPU may initialize the GPU memory to default values and begin a subsequent rendering pass with respect to a different bin 110.

In accordance with aspects of the present disclosure, a device, for example a CPU or a GPU, may utilize a pre-fetch engine (PFE) to fetch, for each bin, a subset of entries corresponding to visible draw calls of a FSDT, the FSDT comprising a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin.

A PFE may be a hardware or software component which is configured to fetch one or more entries corresponding to draw calls from a memory.

By fetching only the subset of entries corresponding to visible draw calls, the number of FSDT table entries to be fetched from a memory can be reduced. This allows for a more efficient use of time, power and computational resources of the device.

In accordance with aspects of the present disclosure, pixels which are invisible within the bin may be at least one of: located outside of the respective bin; and occluded, e.g., by other objects that are to be rendered.

In accordance with aspects of the present disclosure, the device may utilize a command processor (CP) to execute the fetched subset of entries corresponding to visible draw calls. By executing the draw calls only for the subset of entries corresponding to draws which are visible, the computational requirements of the CP, such as time and power consumption, as well as the consumption of computational capacities, can be reduced, thus allowing for a more efficient use of time, power and computational resources of the device.

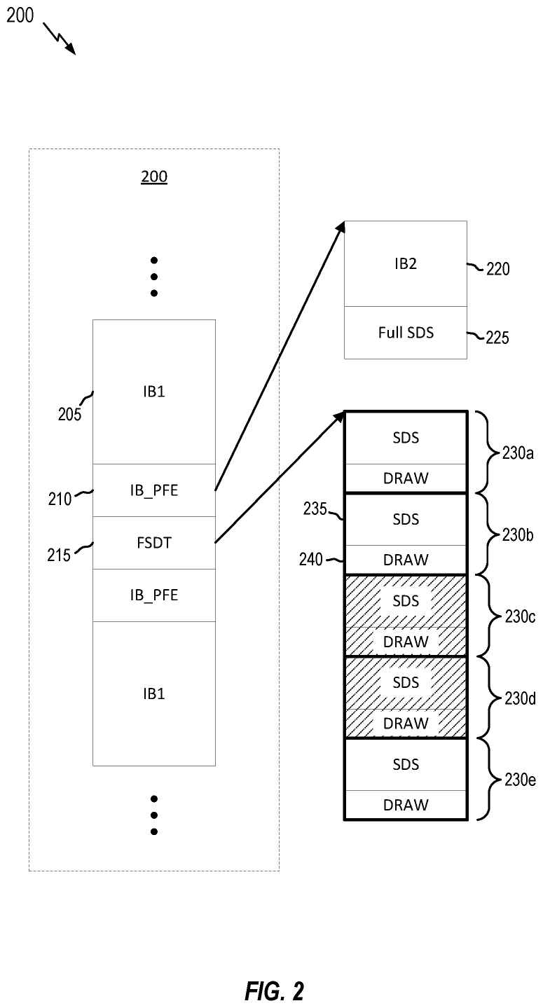

FIG. 2 illustrates an example of a command stream 200 that supports fixed-stride draw tables for tiled rendering in accordance with aspects of the present disclosure. Command stream 200 may, for example, be passed from a CPU of a device to a GPU and may control rendering operations performed by the GPU. Command stream 200 may include one or more levels of indirection (e.g., indirect buffer 1 (IB1) 205, IB packet forwarding engines (IB_PFEs) 210) and FSDT entries 215.

For example, IB1 205 may contain information related to register states, shading operations, texturing operations, visibility pass information (e.g., the visibility streams discussed herein), or other such information. IB_PFE 210 may index IB2 command packets (e.g., which may contain IB2 information 220 and a SET_DRAW_STATE (SDS) vector 225).

Each FSDT entry 215 may include a plurality of FSDT repetitions 230. For example, each FSDT repetition 230 may include SDS information 235 and draw command 240. Each FSDT repetition 230 may be associated with one or more (e.g., or all) bins for a given frame. A FSDT repetition 230 may also be referred to as “table entry” or “FSDT table entry”.

In accordance with aspects of the present disclosure, the command stream 200 may comprise only a subset of visible draws of the FSDT. The repetitions 230c and 230d of the FSDT may correspond to invisible draws and may thus not have been fetched, such that only the subset of visible FSDT draws may have been fetched. In the example illustrated in FIG. 2, a list of visible draws may be {1, 2, 5} such that the visible draw may correspond to the table entries 230a, 230b and 230e of the FSDT. Consequently, the FSDT table entries 230c and 230d may correspond to invisible draws for the current bin of interest, such that they may not have to be processed by the CP. In this way, the superfluous usage of time, power and computational resources by fetching invisible draws can be avoided.

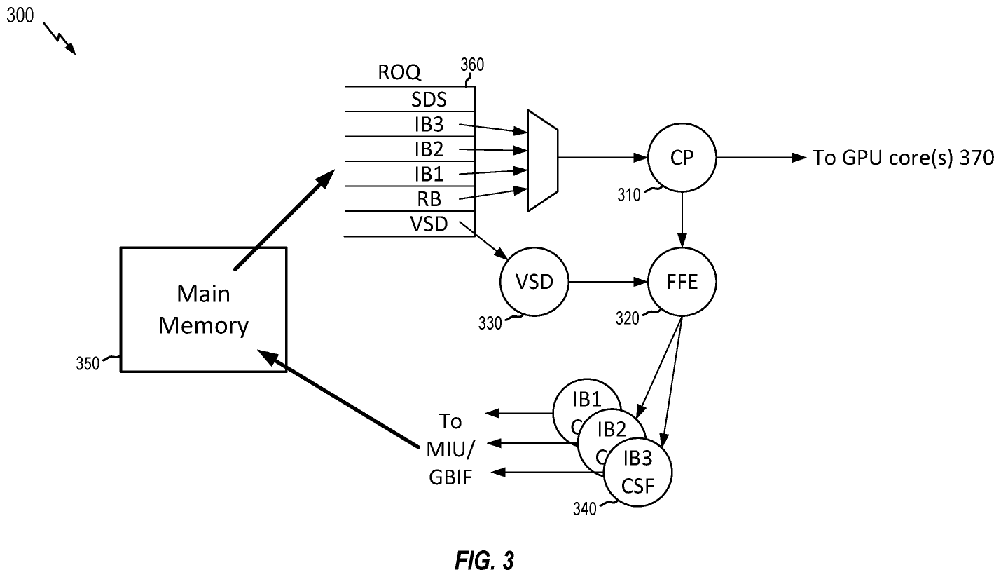

FIG. 3 is a flow diagram illustrating the fetching process of the FSDT Fetch engine (FFE), sometimes also denoted as pre-fetch engine (PFE) in accordance with aspects of the present disclosure.

In accordance with aspects of the present disclosure, the GPU may comprise CP 310 and a FFE 320. The FFE 320 may be provided in addition to current GPU hardware and preferably does not replace or eliminate any existing hardware components. In some aspects of the present disclosure, the CP 310 may be utilized for programming the FFE 320 with one or more of a base address of the FSDT table, a stride parameter (e.g., the step size or spacing) of the FSDT table, a first draw of the FSDT table, and a number of entries of the FSDT table. This allows for the FFE 320 to accurately address respective entries of the FSDT, such that the required table entries can be fetched from the memory, therefore increasing efficiency of the pre-fetching method.

In accordance with aspects of the present disclosure, the FFE 320 may receive a list of visible draws from a visibility stream decoder (VSD) 330. A visibility stream decoder may be a hardware or software component configured to generate a list of visible draws for a frame. The list of visible draws may be in reference to a FSDT, i.e., the list may reference the respective visible draws with respect to their location in the FSDT.

In accordance with some aspects of the present disclosure, the FFE 320 may fetch the subset entries corresponding to of visible draw calls based on the list of visible draws. According to some aspects of the present disclosure, receiving the list of visible draws from the VSD may comprise receiving, by the PFE, the list of visible draws from the VSD based on one or more of the base address of the FSDT table, the stride parameter of the FSDT table, the first draw of the FSDT table, and the number of entries of the FSDT table.

This allows for accurate addressing of the respective entries of the FSDT, such that latency as well as the amount of required computational resources can be reduced, thus increasing efficiency of the method.

In accordance with some aspects of the present disclosure, the list of visible draws may indicate only the draw calls that draw pixels in the respective bin.

This allows for a more efficient use of computational resources as only the draw calls corresponding to visible pixels are in the list of visible draws. This way, draw calls representing invisible pixels do not need to be fetched from the memory, and therefore also do not have to be processed by the CP.

In accordance with some aspects of the present disclosure, the list of visible draws may index the entries corresponding to visible draw calls to be fetched via their position in the FSDT.

This allows for an easy and resource-efficient way of addressing respective entries corresponding to visible draw calls of the FSDT.

In accordance with some aspects of the present disclosure, fetching the subset of entries corresponding to visible draw calls may comprise, for each visible draw call, sending, by the FFE 320, a fetch request to a memory device, e.g., the main memory 350 of the GPU, storing the FSDT table. Preferably, the memory device may be common at least to the CP and to a host CPU, e.g., the GPU core(s).

Fetching the subset of entries corresponding to visible calls, and not to the invisible calls, from the FSDT allows for a more efficient use of time, power and computational resources, because only the draw calls which correspond to visible pixels of the current bin of interest need to be fetched.

In accordance with aspects of the present disclosure, the FFE 320 may fetch the entries corresponding to visible draw calls in Command Stream Fetchers (CSFs) 340 which may be utilized to fetch the respective FSDT table entries from a memory device, e.g., from the main memory 350 of the GPU. By means of the CSFs 340, the respective FSDT table entries may be fetched into indirect buffers (IBs), such as for example IB2 and/or IB3. In some aspects, the main memory 350 may be accessed by a Memory Interface Unit (MIU).

In accordance with aspects of the present disclosure, the subset of entries corresponding to visible draw calls may be fetched by a direct memory access (DMA) engine from the memory device, such as the main memory 350. This provides for a fast and efficient way of accessing the memory, thus increasing the fetching efficiency.

From the main memory 350, the respective FSDT table entries corresponding to the visible draw calls may be fetched into the memory 360. In some examples, memory 360 may be an on-chip memory.

In accordance with some aspects of the present disclosure, the method for rendering may further comprise generating a command stream of visible draw calls by concatenating the subset of fetched entries corresponding to visible draw calls. In some examples, the entries corresponding to visible draw calls may be concatenated into one command stream.

By concatenating the subset of fetched visible draw calls, unnecessary computational overhead can be avoided, and the efficiency of the fetching procedure can be increased by means avoiding waiting and jumping around disjoint entries of the FSDT.

Thus, according to FIG. 3 a graphics processing unit (GPU) may be provided. The GPU may comprise one or more GPU cores 370, a command processor (CP) 310 operably connected with the GPU core(s) 370, a pre-fetch engine (PFE) operably connected with the CP 310 and the GPU core(s) 370; and on-chip-memory 360 in communication with the GPU core(s) 370, the CP 310 and the PFE. The GPU may be configured to render a frame by dividing the frame to be rendered into a plurality of bins and for each bin of the plurality of bins:
fetching, by the PFE, a subset of entries corresponding to visible draw calls of an FSDT that comprises a plurality of entries corresponding to visible and invisible draw calls for the bin, wherein a visible draw call may comprise instructions for drawing one or more pixels which are visible within the bin and wherein an invisible draw call may only comprise instructions for drawing pixels which are invisible within the bin; and
executing, by the CP 310, the fetched subset of entries corresponding to visible draw calls, causing the GPU core(s) 370 to render the frame.

In accordance with aspects of the present disclosure, pixels which are invisible within the bin may be at least one of:
located outside of the respective bin; and
occluded.

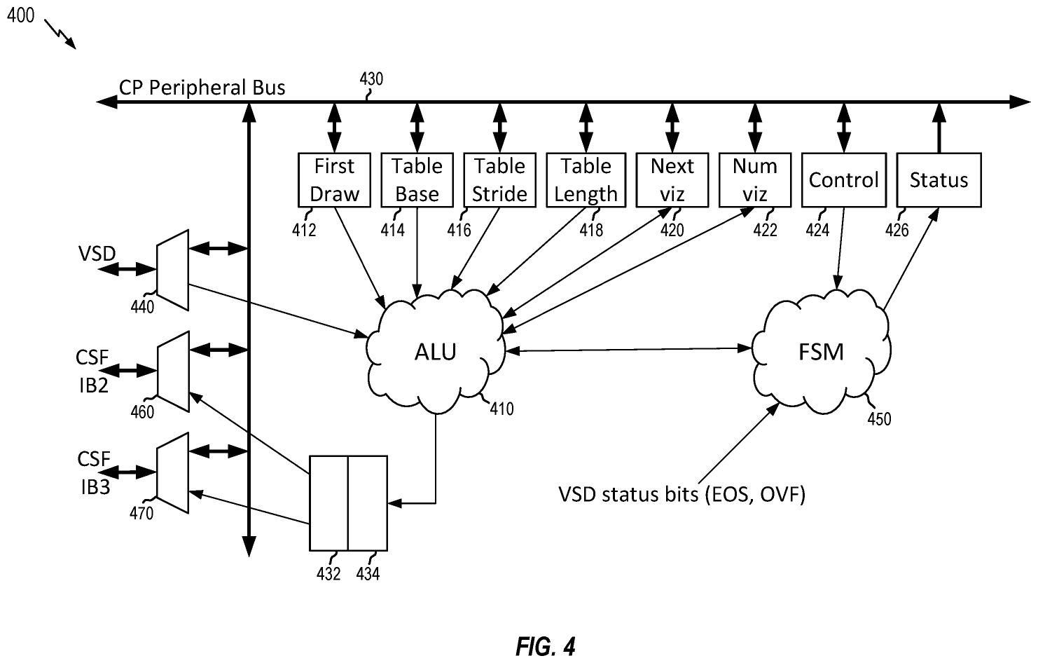

A PFE may for example be the FSDT Fetching Engine (FFE) 320, which is described in more detail with respect to FIG. 4. For the sake of simplicity, the embodiments below refer to FFE 320, but it is to be understood that other PFEs than the FFE described with respect to FIG. 4 can be utilized within the scope of the present disclosure.

In some aspects of the present disclosure, the GPU may further comprise a visible stream decoder (VSD) 330 which may be configured to generate a list of visible draws for each bin. The FFE 320 may be configured to fetch the subset of entries corresponding to visible draw calls based on the list of visible draws generated by the VSD 330.

In some aspects of the present disclosure, the list of visible draws may indicate only the draw calls that draw pixels in the bin. This allows for a more efficient use of computational resources as only the draw calls corresponding to visible pixels are in the list of visible draws. This way, draw calls representing invisible pixels do not need to be fetched from the memory, and therefore also do not have to be processed by the CP.

In some aspects of the present disclosure, the list of visible draws indexes the entries corresponding to visible draw calls to be fetched via their position in the FSDT. This allows for an easy and resource-efficient way of addressing respective draw calls of the FSDT.

In some aspects of the present disclosure, the FFE 320 may be configured to fetch the subset of entries corresponding to visible draw calls by sending for each draw call to be fetched a fetch request to a memory device 350 that is operably connected to the GPU and that may store the FSDT table. Preferably, the memory device may be common at least to the CP and to a host CPU, e.g., the GPU core(s). Fetching the subset of entries corresponding to visible calls, and not to the invisible calls, from the FSDT allows for a more efficient use of time, power and computational resources, because only the draw calls which correspond to visible pixels of the current bin of interest need to be fetched.

In some aspects of the present disclosure, the FFE 320 may be configured to fetch the subset of entries corresponding to visible draw calls from the memory device 350 via using a direct memory access (DMA) engine. This provides for a fast and efficient way of accessing the memory, thus increasing the fetching efficiency.

In some aspects of the present disclosure, the CP 310 may be further configured to program the FFE 320 with one or more of a base address of the FSDT table, a stride parameter of the FSDT table, a first draw of the FSDT table, and a number of entries of the FSDT table. This allows for the FFE 320 to accurately address respective entries of the FSDT, such that the required table entries can be fetched from the memory, therefore increasing efficiency of the pre-fetching method.

In some aspects of the present disclosure, the FFE 320 may be configured to receive the list of visible draws from the VSD 330 based on one or more of the base address of the FSDT table, the stride parameter of the FSDT table, the first draw of the FSDT table, and the number of entries of the FSDT table. This allows for accurate addressing of the respective entries of the FSDT, such that latency as well as the amount of required computational resources can be reduced, thus increasing efficiency of the method.

In some aspects of the present disclosure, the CP 310 may be further configured to generate a command stream of visible draw calls by concatenating the subset of fetched entries corresponding to visible draw calls. By concatenating the subset of fetched entries corresponding to visible draw calls, unnecessary computational overhead can be avoided, and the efficiency of the fetching procedure can be increased by means avoiding waiting and jumping around disjoint entries of the FSDT.

In some aspects of the present disclosure, the FFE 320 may be implemented in hardware on the GPU and may comprise one or more of an arithmetic logic unit (ALU), a finite state machine (FSM) and a plurality of peripheral PFE registers. This may reduce the error-proneness of the application by providing it in hardware instead of a software solution, thus improving the overall reliability of the GPU.

In some aspects, the GPU may further comprise one or more hardware implemented multiplexers for connecting the FFE 320 to one or more of the VSD 330 and a command stream fetcher (CSF) 340. This may reduce the error-proneness of the application by providing it in hardware instead of a software solution, thus improving the overall reliability of the GPU.

FIG. 4 illustrates the structure of an FFE in accordance with aspects of the present disclosure.

According to FIG. 4, the FFE may comprise an arithmetic logic unit (ALU) 410. The ALU 410 may receive from the CP, for example via a CP peripheral bus 430, one or more FFE peripheral registers. The FFE peripheral register may comprise a table base 414, table length 418 and table stride 416 of the FSDT table. The table base may indicate a basis of the FSDT, for example, a starting point of the FSDT. The table length 418 may indicate a length of the FSDT. The table stride 416 may indicate a width of an individual table entry, i.e., the difference in width between the start of one table entry and the start of the subsequent entry. The table base 414, table stride and table length may be copied from an FSDT PM4 packet.

The FFE peripheral register may further comprise a first draw 412. The first draw 412 may indicate the draw number of the first draw of the FSDT table. The first draw 412 may be calculated and/or written by microcode. In some examples, a plurality of FSDT tables may be concatenated, such that the first draw 412 of one of the plurality of FSDTs may be different from 1. For example, multiple FSDTs with ten draws per FSDT may be concatenated. Then, the first draw 412 of the second table may be “draw 10”.

The ALU 410 may further receive data from the VSD 440. The data from the VSD 440 may comprise one or more of a next visible draw (Next viz) 420 and a number of consecutive visible draws (Num viz) 422 of the FSDT. The next visible draw 420 may indicate the next draw of the FSDT which is visible in a respective bin of interest. The number of visible draws 422 may indicate how many of the draws subsequent to the first visible draw are also visible in the respective bin.

The ALU 410 may share the next visible draw 420 and/or the number of consecutive draws 422 with the CP, for example via a CP peripheral bus 430.

The ALU 410 may then calculate a next base 432 and a fetch length 434 based on the received FSDT table data from the CP and the next visible draw(s) data received from the VSD 440. The FFE, for example via the ALU 410, may thus have reading access to the FSDT in the main memory, as well as to visible draw(s) data of the VSD.

The VSD may further provide VSD status data to the FFE, such as end of screen (EOS), overflow (OVF), or indications of errors. In some aspects, the VSD status data may be provided to the FFE via a dedicated wire.

In some aspects of the present disclosure, the next base 432 may be calculated as

$${N}_{b a s e} = {T}_{b} + {T}_{str} \cdot ( {v}_{next} - {D}_{first} ) \qquad ( 1 )$$

with N_{base} being the next base 432, T_{b} being the table base 414, Tₛₜᵣ being the table stride 416, vₙₑₓₜ being the next visible draw 420 and D_{first} being the first draw 412.

The fetch length 434 (F_{L}) may be calculated as the product of table stride 416 and the number of visible draws 422 (vₙᵤₘ):

$${F}_{L} = {T}_{str} \cdot {v}_{n u m} \qquad ( 2 )$$

The next base 432 and fetch length 434 may then be provided to the CSFs 460 and 470 which may then fetch the respective draws from the FSDT.

Thus, an example fetching algorithm for the FFE may be equal or similar to the following:

```
While ! (end-of-table or end-of-draws) {
  N_{base} = T_{Base} + T_{Str} * (vₙₑₓₜ − D_{first});
  F_{L} = T_{Str} * vₙᵤₘ;
  Issue fetch to CSF;
}
```

The FFE may provide the calculated next base 432 and fetch length 434 to the appropriate CSF, as for example the CSF 460 for IB2 and/or the CSF 470 for IB3.

The FFE may further comprise a Finite State Machine (FSM) 450. The FSM 450 may be in communication with the ALU 410. The FSM 450 may be further configured to communicate with the CP, for example via CP peripheral bus 350.

For example, the FSM 450 may receive control information 424 from the CP, for example via CP peripheral bus 430. Further, the FSM 450 may transmit status information 426 to the CP, for example via P peripheral bus 430.

The control information 424 may comprise action bits, such as “Reset”, “Halt” and “Go”. Further, the control information 424 may comprise an indication of which CSF 460, 470 should be used for fetching, and which indirect buffer (for example IB1, IB2 or IB3) should be used for the fetched FSDT table entries in the on-chip memory 460.

The status information 426 may comprise information on the state of the FFE. For example, the status information 426 may indicate that the FFE is currently busy or idle. Further, the status information 426 may indicate a number of CSF fetches issued by the FFE. In some aspects of the present disclosure, the status information 426 may comprise a number of FSDT table entries that must still be processed by the FFE. This value may change dynamically during the fetching process.

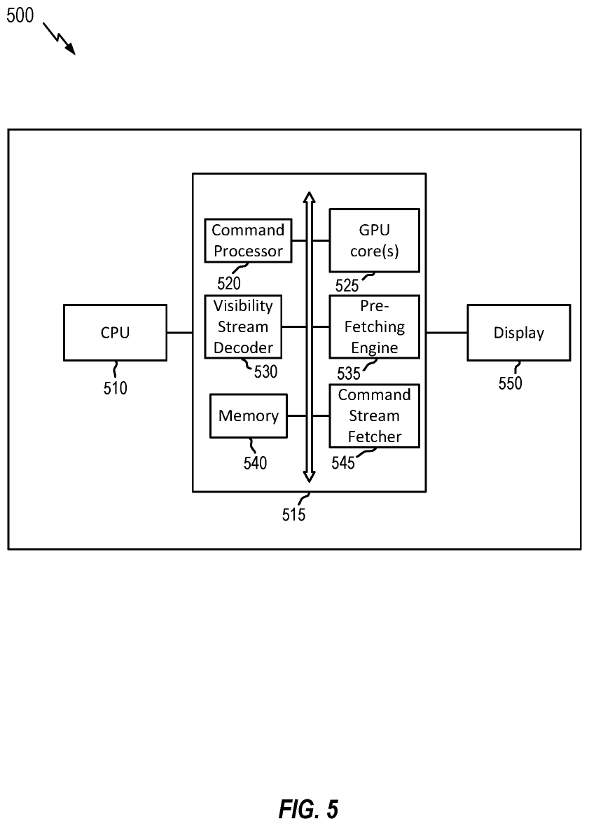

FIG. 5 shows a block diagram of a device 500 that supports FSDTs for rendering in accordance with aspects of the present disclosure. The device 500 may be an example of aspects of a device as described herein. The device 500 may include a central processing unit (CPU) 510, a graphics processing unit (GPU) 515 and a display 550. The GPU 515 may include a command processor (CP) 520, one or more GPU cores 525, a visibility stream decoder (VSD) 530, a Pre-Fetching engine (PFE) 535, for example an FSDT Fetching engine as described elsewhere herein, a memory 540, and one or more command stream fetchers (CSF) 545. Each of these modules may communicate, directly or indirectly, with one another (e.g., via one or more buses).

CPU 510 may execute one or more software applications, such as web browsers, graphical user interfaces, video games, or other applications involving graphics rendering for image depiction (e.g., via display 550). As described above, CPU 510 may encounter a GPU program (e.g., a program suited for handling by a GPU) when executing the one or more software applications. Accordingly, CPU 510 may submit rendering commands (e.g., a command stream) to a CP 520 of the GPU 515 (e.g., via a GPU driver containing a compiler for parsing API-based commands).

The GPU 515, or its sub-components, may be implemented in hardware, code (e.g., software or firmware) executed by a processor, or any combination thereof. If implemented in code executed by a processor, the functions of the GPU 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The GPU 515, or its sub-components, may be physically located at various positions, including being distributed such that portions of functions are implemented at different physical locations by one or more physical components. In some examples, the GPU 515, or its sub-components, may be a separate and distinct component in accordance with various aspects of the present disclosure. In some examples, the GPU 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The CP 520 or the GPU core(s) 525 may divide a frame into a set of bins. The CP 520 may execute a fetched subset of entries corresponding to visible draw calls, causing the GPU cores 525 to render the frame.

The CP 520 may further generate a command stream including a subset of entries corresponding to visible draw calls of a FSDT, wherein the FSDT may comprise a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin. In some examples, an invisible draw call may be located outside the respective bin. In some examples, an invisible draw call may be located within the respective bin, but may be occluded (i.e., covered by another object, such as another draw call). In some examples, the CP 520 may pass the command stream to the GPU core(s) 525.

The VSD 530 may identify, for each bin, a subset of the FSDT table entries containing visible draw calls within the respective bin. In some examples, the VSD 530 may generate a list of visible draws based on the entries of the FSDT.

The Pre-Fetching engine 535 may be configured to fetch the subset of entries corresponding to visible draw calls of an FSDT. In some examples, the subset of entries corresponding to visible draw calls may be based on the list of visible draws received from the VSD 530. The Pre-Fetching engine 535 may fetch the subset of entries corresponding to visible draw calls by addressing the CSF 545.

The CSF 545 may fetch a table entry of the FSDT from the memory 540 into indirect buffers (IBs).

The CP 520 or the GPU core(s) 525 may execute one or more rendering commands for each bin based on the corresponding subset of the set of FSDT table entries.

Display 550 may display content generated by other components of the device. In some examples, display 550 may be connected with a display buffer which stores rendered data until an image is ready to be displayed. Display 550 represents a unit capable of displaying video, images, text or any other type of data for consumption by a viewer. Display 550 may include a liquid-crystal display (LCD), a light emitting diode (LED) display, an organic LED (OLED), an active-matrix OLED (AMOLED), or the like.

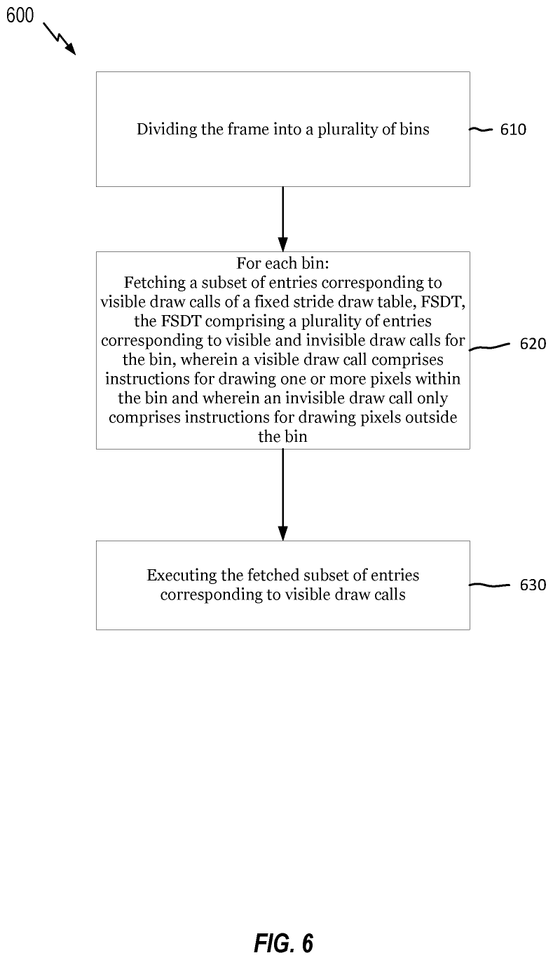

FIG. 6 shows a flowchart illustrating a method 600 for rendering a frame in accordance with aspects of the present disclosure. The method 600 may be carried out for example by a graphics processor unit (GPU) comprising a pre-fetch engine (PFE) and a command processor (CP). One example for a PFE may be an FSDT fetching engine (FFE) as has been described above with respect to FIGS. 3 and 4.

According to FIG. 6, the method 600 may comprise dividing 610 the frame into a plurality of bins.

According to FIG. 6, the method 600 may further comprise for each bin: Fetching 620 a subset of entries corresponding to visible draw calls of a fixed stride draw table (FSDT) the FSDT comprising a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin. Step 620 may be carried out by the pre-fetch engine of the GPU.

In some aspects of the present disclosure, pixels which are invisible within the bin are at least one of:
located outside of the respective bin; and
occluded.

Occluded pixels may be pixels which are located behind another object, such that they may be invisible within a bin although they may be located within the respective bin.

In some aspects of the present disclosure, the method 600 may further comprise receiving a list of visible draws, e.g., from a visibility stream decoder (VSD) and fetching the subset of entries corresponding to visible draw calls based on the list of visible draws.

In some aspects of the present disclosure, the list of visible draws may indicate only the draw calls that draw pixels in the bin.

This allows for a more efficient use of computational resources as only the draw calls corresponding to visible pixels are in the list of visible draws. This way, FSDT table entries corresponding to draw calls representing invisible pixels do not need to be fetched from the memory, and therefore also do not have to be processed by the CP.

In some aspects of the present disclosure, the list of visible draws may index the entries corresponding to visible draw calls to be fetched via their position in the FSDT.

This allows for an easy and resource-efficient way of addressing respective entries corresponding to draw calls of the FSDT.

In some aspects of the present disclosure, fetching the subset of entries corresponding to visible draw calls may comprise, for each visible draw call, sending a fetch request to a memory device storing the FSDT table.

Fetching the subset of entries corresponding to visible calls, and not to the invisible calls, from the FSDT allows for a more efficient use of time, power and computational resources, because only the entries corresponding to draw calls which correspond to visible pixels of the current bin of interest need to be fetched.

In some aspects of the present disclosure, the subset of entries corresponding to visible draw calls may be fetched by a direct memory access, DMA, engine from the memory device. This provides for a fast and efficient way of accessing the memory, thus increasing the fetching efficiency.

In some aspects of the present disclosure, the method 600 may further comprise programming the PFE with one or more of a base address of the FSDT table, a stride parameter of the FSDT table, a first draw of the FSDT table, a first draw of the FSDT table, and a number of entries of the FSDT table. This allows for the PFE/FFE to accurately address respective entries of the FSDT, such that the required table entries can be fetched from the memory, therefore increasing efficiency of the pre-fetching method.

In some aspects of the present disclosure, receiving the list of visible draws from the VSD may comprise receiving the list of visible draws from the VSD based on one or more of the base address of the FSDT table, the stride parameter of the FSDT table, the first draw of the FSDT table, and the number of entries of the FSDT table. This allows for accurate addressing of the respective entries of the FSDT, such that latency as well as the amount of required computational resources can be reduced, thus increasing efficiency of the method.

In some aspects of the present disclosure, the method 600 may further comprise generating a command stream of visible draw calls by concatenating the subset of fetched entries corresponding to visible draw calls.

By concatenating the subset of fetched entries corresponding to visible draw calls, unnecessary computational overhead can be avoided, and the efficiency of the fetching procedure can be increased by means avoiding waiting and jumping around disjoint entries of the FSDT.

According to FIG. 6, the method 600 may further comprise executing 630 the fetched subset of entries corresponding to visible draw calls.

In the following, several further aspects of the present disclosure are presented:
Aspect 1. A method for rendering a frame, the method being executed by a graphics processor, the method comprising: dividing the frame into a plurality of bins; for each bin of the plurality of bins: fetching a subset of entries corresponding to visible draw calls of a fixed stride draw table (FSDT) the FSDT comprising a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin; and executing the fetched subset of entries corresponding to visible draw calls.
Aspect 2. The method of aspect 1, wherein the graphics processor comprises a pre-fetch engine (PFE) and a command processor (CP) and wherein the fetching is performed by the PFE and the executing is performed by the CP.
Aspect 3. The method of any one of aspects 1 and 2, wherein pixels which are invisible within the bin are at least one of:
located outside of the respective bin; and
occluded.
Aspect 4. The method of any one of aspects 1 to 3, further comprising: receiving a list of visible draws from a visibility stream decoder (VSD); and fetching, preferably by the pre-fetch engine, the subset of entries corresponding to visible draw calls based on the list of visible draws.
Aspect 5. The method of aspect 4, wherein for each bin, the list of visible draws indicates only the draw calls that draw pixels in the bin.
Aspect 6. The method of any one of aspects 4 and 5, wherein the list of visible draws indexes the entries corresponding to visible draw calls to be fetched via their position in the FSDT.
Aspect 7. The method of any one of aspects 4 to 6, wherein fetching the subset of entries corresponding to visible draw calls comprises, for each visible draw call, sending, preferably by the PFE, a fetch request to a memory device storing the FSDT table.
Aspect 8. The method of any one of aspects 1 to 7, wherein the subset of entries corresponding to visible draw calls is fetched by a direct memory access (DMA) engine from the memory device.
Aspect 9. The method of any one of aspects 2 to 8, further comprising: programming, preferably by the CP, the PFE with one or more of a base address of the FSDT table, a stride parameter of the FSDT table, a first draw of the FSDT table, and a number of entries of the FSDT table.
Aspect 10. The method of aspect 9, wherein receiving the list of visible draws from the VSD comprises receiving, preferably by the PFE, the list of visible draws from the VSD based on one or more of the base address of the FSDT table, the stride parameter of the FSDT table, the first draw of the FSDT table, and the number of entries of the FSDT table.
Aspect 11. The method of any one of aspects 1 to 10, further comprising: generating a command stream of visible draw calls by concatenating the subset of fetched entries corresponding to visible draw calls.
Aspect 12. An apparatus comprising: one or more processors; a memory in communication with the one or more processors; wherein the apparatus is configured to render a frame by: dividing the frame to be rendered into a plurality of bins; and for each bin of the plurality of bins: fetching a subset of entries corresponding to visible draw calls of a fixed stride draw table (FSDT) that comprises a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin; and executing the fetched subset of entries corresponding to visible draw calls, causing the one or more processors to render the frame.
Aspect 13. The apparatus of aspect 12, further comprising: a command processor (CP) operably connected with the one or more processors; and a pre-fetch engine (PFE) operably connected with the CP and the one or more processors, wherein the fetching is performed by the PFE and the executing is performed by the CP.
Aspect 14. The apparatus according to any one of aspects 12 and 13, wherein pixels which are invisible within the bin are at least one of:
located outside of the respective bin; and
occluded.
Aspect 15. The apparatus of any one of aspects 13 and 14, further comprising: a visible stream decoder (VSD) configured to generate a list of visible draws for each bin; and wherein the PFE is configured to fetch the subset of entries corresponding to visible draw calls based on the list of visible draws generated by the VSD.
Aspect 16. The apparatus of aspect 15, wherein for each bin, the list of visible draws indicates only the draw calls that draw pixels in the bin.
Aspect 17. The apparatus of any one of aspects 15 and 16, wherein the list of visible draws indexes the entries corresponding to visible draw calls to be fetched via their position in the FSDT.
Aspect 18. The apparatus of any one of aspects 15 to 17, wherein the PFE is configured to fetch the subset of entries corresponding to visible draw calls by sending for each draw call to be fetched a fetch request to a memory device that is operably connected to the GPU and that stores the FSDT table.
Aspect 19. The apparatus of any one of aspects 13 to 18, wherein the PFE is configured to fetch the subset of entries corresponding to visible draw calls from the memory device via using a direct memory access (DMA) engine.
Aspect 20. The apparatus of any one of aspects 13 to 19, wherein the CP is further configured to program the PFE with one or more of a base address of the FSDT table, a stride parameter of the FSDT table, a first draw of the FSDT table, and a number of entries of the FSDT table.
Aspect 21. The apparatus of aspect 20, wherein the PFE is configured to receive the list of visible draws from the VSD based on one or more of the base address of the FSDT table, the stride parameter of the FSDT table, the first draw of the FSDT table, and the number of entries of the FSDT table.
Aspect 22. The apparatus of any one of aspects 13 to 21, wherein the CP is further configured to generate a command stream of visible draw calls by concatenating the subset of fetched entries corresponding to visible draw calls.
Aspect 23. The apparatus of any one of aspects 13 to 22, wherein the PFE is implemented in hardware on the GPU and comprises one or more of an arithmetic logic unit (ALU) a finite state machine (FSM) and a plurality of peripheral PFE registers.
Aspect 24. The apparatus of any one of aspects 11 to 21, further comprising one or more hardware implemented multiplexers for connecting the PFE to one or more of the VSD, and a command stream fetcher (CSF).
Aspect 25. The apparatus according to any one of aspects 12 to 24, wherein the apparatus is a wireless communication device.
Aspect 26. A non-transitory computer-readable medium storing code for rendering at a device, the code comprising instructions executable by a processor to perform the method of any one of aspects 1 to 11.
Aspect 27. A computer program comprising instructions which, when the program is executed by a computer, cause the computer to carry out the method of any of aspects 1 to 11.
Aspect 28. An apparatus comprising means for performing the method of any one of aspects 1 to 11.

It should be noted that the methods described above describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for rendering a frame, the method being executed by a graphics processor, the method comprising:
dividing the frame into a plurality of bins;
for each bin of the plurality of bins:
fetching a subset of entries corresponding to visible draw calls of a fixed stride draw table, FSDT, the FSDT comprising a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin; and
executing the fetched subset of entries corresponding to visible draw calls.

2. The method of claim 1, wherein the graphics processor comprises a pre-fetch engine, PFE, and a command processor, CP, and wherein the fetching is performed by the PFE and the executing is performed by the CP.

3. The method of claim 1, wherein pixels which are invisible within the bin are at least one of: located outside of the respective bin; and occluded.

4. The method of claim 2, further comprising:
receiving a list of visible draws from a visibility stream decoder, VSD; and
fetching, by the pre-fetch engine, the subset of entries corresponding to visible draw calls based on the list of visible draws.

5. The method of claim 4, wherein for each bin, the list of visible draws indicates only the draw calls that draw pixels in the bin.

6. The method of claim 5, wherein the list of visible draws indexes the entries corresponding to visible draw calls to be fetched via their position in the FSDT.

7. The method of claim 4, wherein fetching the subset of entries corresponding to visible draw calls comprises, for each visible draw call, sending, by the PFE, a fetch request to a memory device.

8. The method of claim 7, wherein the subset of entries corresponding to visible draw calls is fetched by a direct memory access, DMA, engine from the memory device.

9. The method of claim 2, further comprising:
programming, by the CP, the PFE with one or more of a base address of the FSDT table, a stride parameter of the FSDT table, a first draw of the FSDT table, and a number of entries of the FSDT table.

10. The method of claim 4 and claim 9, wherein receiving the list of visible draws from the VSD comprises receiving, by the PFE, the list of visible draws from the VSD based on one or more of the base address of the FSDT table, the stride parameter of the FSDT table, the first draw of the FSDT table, and the number of entries of the FSDT table.

11. The method of claim 2, further comprising:
generating a command stream of visible draw calls by concatenating the subset of fetched entries corresponding to visible draw calls.

12. An apparatus for rendering a frame comprising:
one or more processors;
a memory in communication with the one or more processors;
wherein the apparatus is configured to render a frame by:
dividing the frame to be rendered into a plurality of bins; and
for each bin of the plurality of bins:
fetching a subset of entries corresponding to visible draw calls of an FSDT that comprises a plurality of entries corresponding to visible and invisible draw calls for the bin, wherein a visible draw call comprises instructions for drawing one or more pixels which are visible within the bin and wherein an invisible draw call only comprises instructions for drawing pixels which are invisible within the bin; and
executing the fetched subset of entries corresponding to visible draw calls, causing the one or more processors to render the frame.

13. The apparatus of claim 12, further comprising:
a command processor, CP, operably connected with the one or more processors; and
a pre-fetch engine, PFE, operably connected with the CP and the one or more processors,
wherein the fetching is performed by the PFE and the executing is performed by the CP.

14. The apparatus according to claim 12, wherein pixels which are invisible within the bin are at least one of: located outside of the respective bin; and occluded.

15. The apparatus of claim 13, further comprising:
a visible stream decoder, VSD, configured to generate a list of visible draws for each bin; and wherein the PFE is configured to fetch the subset of entries corresponding to visible draw calls based on the list of visible draws generated by the VSD.

16. The apparatus of claim 15, wherein for each bin, the list of visible draws indicates only the draw calls that draw pixels in the bin.

17. The apparatus of claim 15, wherein the list of visible draws indexes the entries corresponding to visible draw calls to be fetched via their position in the FSDT.

18. The apparatus of claim 15, wherein the PFE is configured to fetch the subset of entries corresponding to visible draw calls by sending for each draw call to be fetched a fetch request to a memory device that is operably connected to the apparatus and that stores the FSDT table.

19. The apparatus of claim 18, wherein the PFE is configured to fetch the subset of entries corresponding to visible draw calls from the memory device via using a direct memory access, DMA, engine.

20. The apparatus of claim 13, wherein the CP is further configured to program the PFE with one or more of a base address of the FSDT table, a stride parameter of the FSDT table, a first draw of the FSDT table, and a number of entries of the FSDT table.

21. The apparatus of claim 15 and claim 20, wherein the PFE is configured to receive the list of visible draws from the VSD based on one or more of the base address of the FSDT table, the stride parameter of the FSDT table, the first draw of the FSDT table, and the number of entries of the FSDT table.

22. The apparatus of claim 13, wherein the CP is further configured to generate a command stream of visible draw calls by concatenating the subset of fetched entries corresponding to visible draw calls.

23. The apparatus of claim 13, wherein the PFE is implemented in hardware on the apparatus and comprises one or more of an arithmetic logic unit, ALU, a finite state machine, FSM, and a plurality of peripheral PFE registers.

24. The apparatus of claim 23, further comprising one or more hardware implemented multiplexers for connecting the PFE to one or more of the VSD, and a command stream fetcher, CSF.

25. The apparatus of claim 12, wherein the apparatus is a wireless communication device.
